(19) United States
(12) Patent Application Publication
(10) Pub. No.: US 2018/0077479 A1
(43) Pub. Date: Mar. 15, 2018

(54) WIRELESS EARBUD LANYARD

(71) Applicant: Kevin K. Johanson, Draper, UT (US)

(72) Inventor: Kevin K. Johanson, Draper, UT (US)

(21) Appl. No.: 15/699,004

(22) Filed: Sep. 8, 2017

Related U.S. Application Data
(60) Provisional application No. 62/385,834, filed on Sep. 9, 2016.

(51) Int. Cl. H04R 1/10; A45F 5/00

(52) U.S. Cl. CPC H04R 1/105; A45F 5/00

(57) ABSTRACT

A wireless earbud lanyard for retaining wireless earbuds. The wireless earbud lanyard includes first and second wireless earbud couplers and a tether. Each of the first and second wireless earbud couplers are configured to attachably and detachably receive therein at least a portion of an elongated portion of a wireless earbud. The wireless earbud couplers are further configured to provide one or more of friction and compression retention to the elongated portion of the wireless earbud, and to allow acoustic coupling to a terminal end of the elongated portion of the wireless earbud. The tether includes a first end coupled to the first wireless earbud coupler and a second end coupled to the second wireless earbud coupler.

### CROSS-REFERENCE TO RELATED APPLICATION

A claim for benefit of priority to the Sep. 9, 2016 filing date of the U.S. Patent Provisional Application No. 62/385,834, titled WIRELESS EARBUD LANYARD (the '834 Provisional Application), is hereby made pursuant to 35 U.S.C. § 119(e). The entire disclosure of the '834 Provisional Application is hereby incorporated herein.

### TECHNICAL FIELD

Embodiments described herein generally relate to wearable wireless transceivers.

### BACKGROUND

Wearable wireless transceivers are increasingly becoming reduced in size. Therefore, these wearable wireless transceivers become increasingly easier to lose or misplace. Further, such devices when not in use have required attention to not result in misplacement.

### BRIEF DESCRIPTION OF THE DRAWINGS

FIG. 1 illustrates an embodiment of a wireless earbud lanyard.

FIG. 2 illustrates an alternate view of the wireless earbud lanyard of FIG. 1.

FIG. 2A illustrates a detailed view for coupling the wireless earbud of the various embodiments described herein.

FIG. 2B illustrates another detailed view for coupling the wireless earbud of the various embodiments described herein.

FIG. 2C illustrates yet another detailed view for coupling the wireless earbud of the various embodiments described herein.

FIG. 3 illustrates an alternate embodiment of a wireless earbud lanyard.

FIG. 3A illustrates a detailed view for coupling the wireless earbud of the various embodiments described herein.

FIG. 3B illustrates another detailed view for coupling the wireless earbud of the various embodiments described herein.

FIG. 4 illustrates yet another embodiment of a wireless earbud lanyard.

FIG. 5 illustrates an alternate view of the wireless earbud lanyard of FIG. 4.

FIG. 5A illustrates a detailed view for coupling the wireless earbud of the various embodiments described herein.

### DETAILED DESCRIPTION

Wireless earbuds may be small and easily lost or separated from a mating earbud. Further, wireless earbuds may be temporarily removed from an ear during a conversation.

In one embodiment, a wireless earbud lanyard may include a first wireless earbud coupler and a second wireless earbud coupler. The first and second earbud couplers each may be shaped to attachably and detachably receive at least a portion of an elongated portion of respective first and second wireless earbuds. A tether may include a first end coupled to the first wireless earbud coupler and a second end coupled to the second wireless earbud coupler.

In another embodiment, a wireless earbud lanyard may include first and second wireless earbud couplers. Each of the first and second wireless earbud couplers may be configured to attachably and detachably receive therein at least a portion of an elongated portion of a wireless earbud and provide one or more of friction and compression retention to the elongated portion of the wireless earbud. The wireless earbud couplers further allow acoustic coupling to a terminal end of the elongated portion of the wireless earbud. A tether may include a first end coupled to the first wireless earbud coupler and a second end coupled to the second wireless earbud coupler.

In a further embodiment, a wireless lanyard may include first and second wireless earbud couplers wherein each of the first and second wireless earbud couplers includes a sleeve with an inner diameter substantially the same as an outer diameter of a cross-section of an elongated portion of a wireless earbud. The sleeve may be configured to attachably and detachably receive therein at least a portion of the elongated portion of a wireless earbud. The sleeve may be further configured for coupling away from a microphone on a terminal end of each of the first and second wireless earbuds. The sleeve may provide one or more of friction and compression retention to the elongated portion of the wireless earbud. A tether may include a first end coupled to the first wireless earbud coupler and a second end coupled to the second wireless earbud coupler.

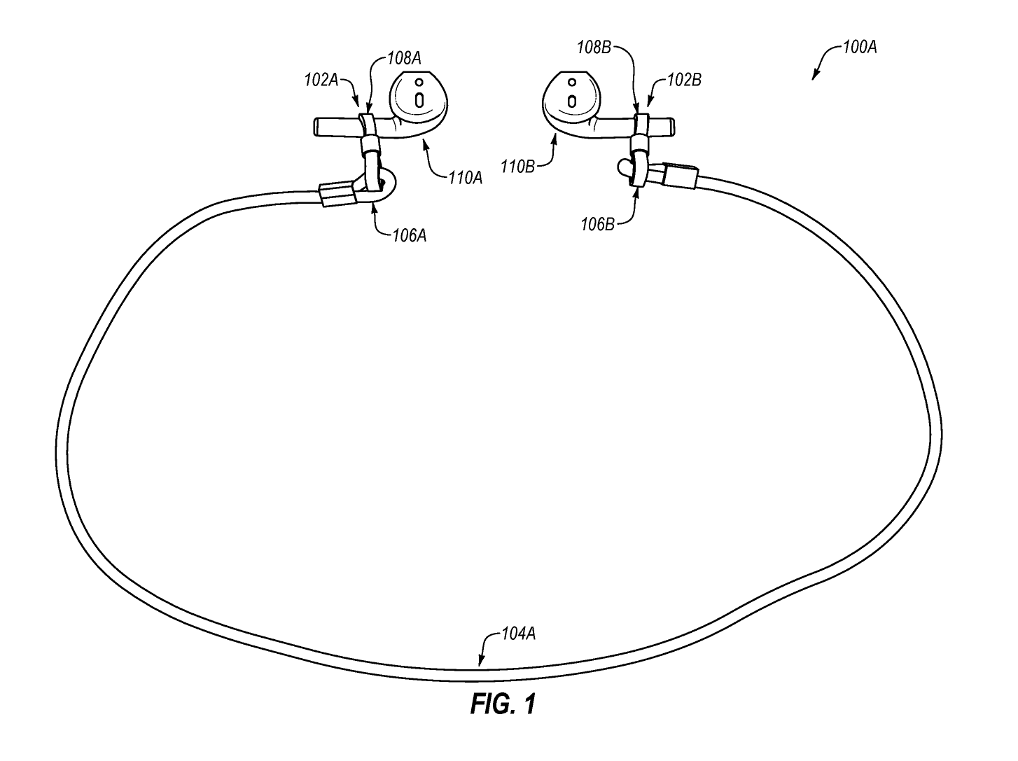

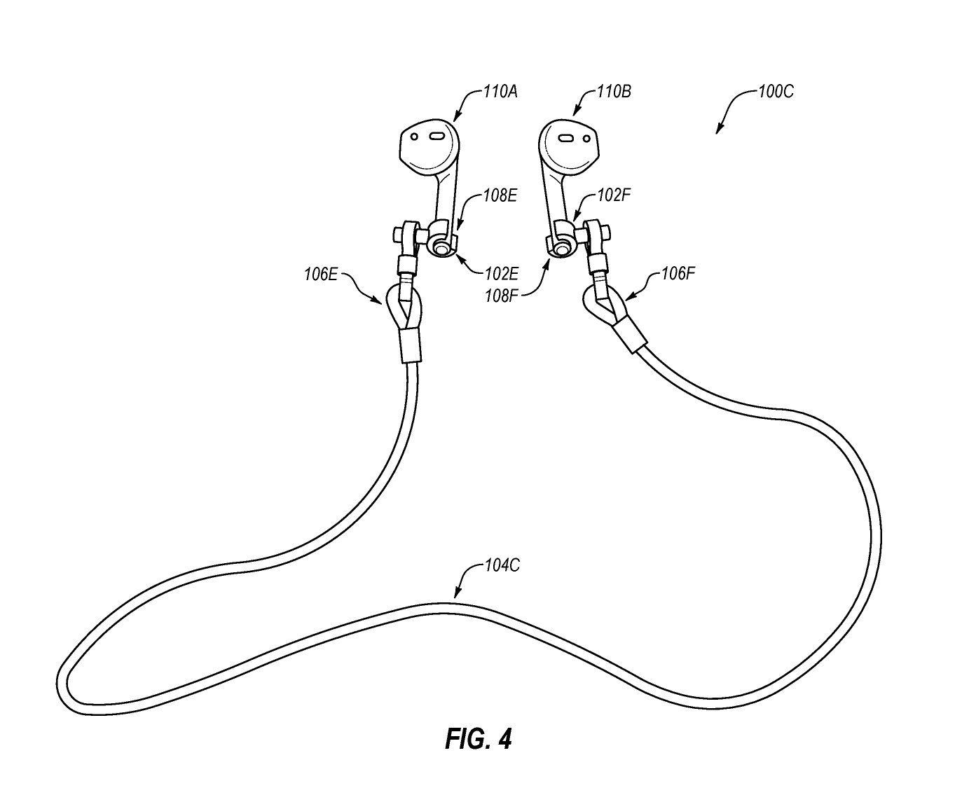

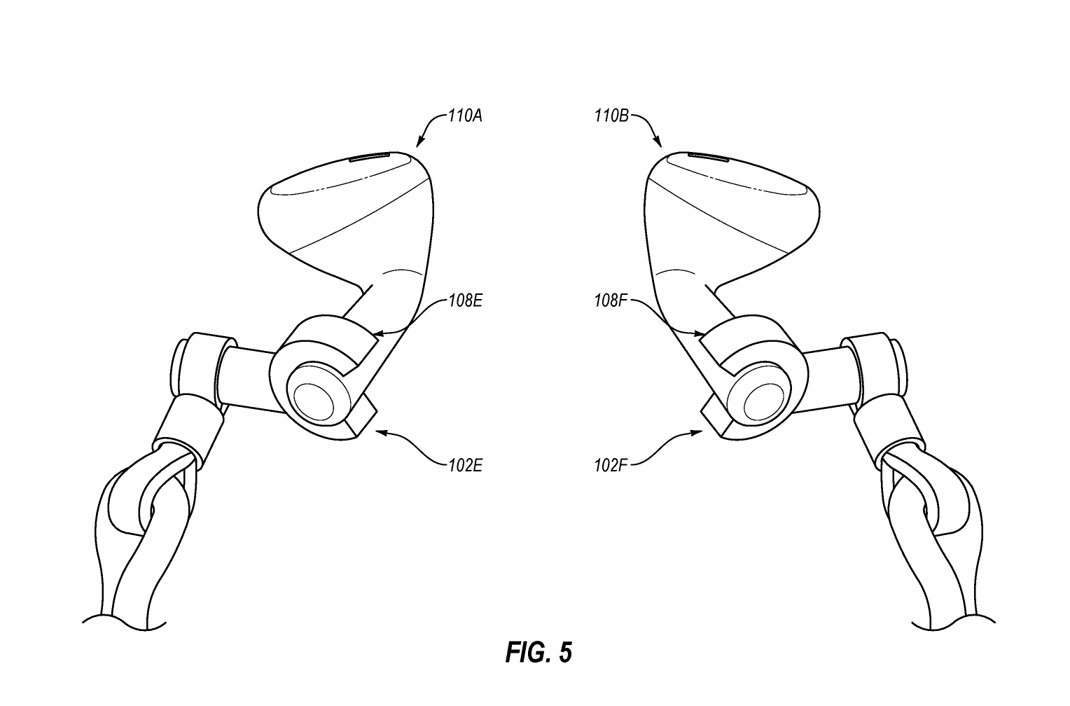

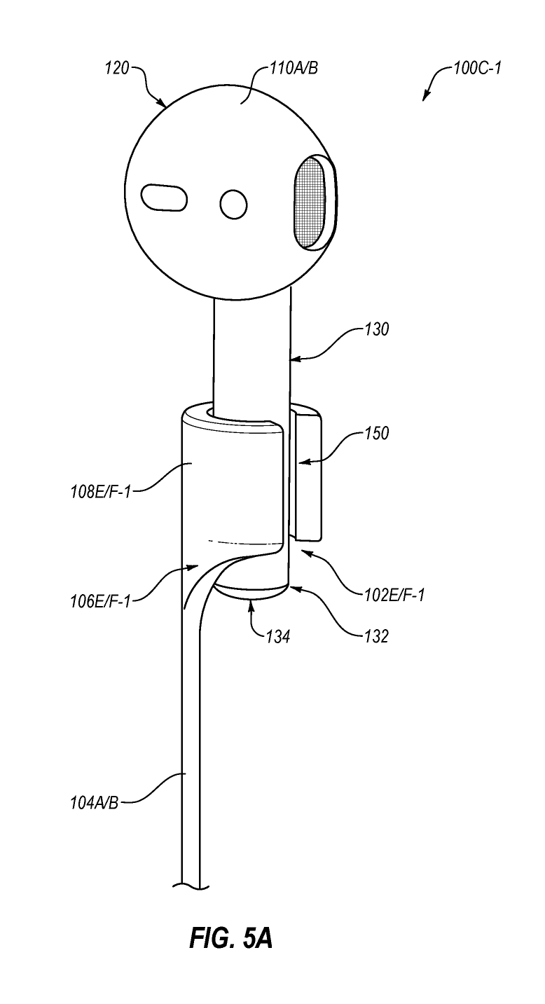

FIG. 1 illustrates a wireless earbud lanyard 100A including a connecting means such as a tether 104A. The wireless earbud lanyard 100A may further include one or more wireless earbud coupling means or wireless earbud couplers 102A and 102B attached at the respective ends of the tether 104A. The tether 104A may be a string, cord, cable, chain, or other similar means. The wireless earbud couplers 102A and 102B may include a structure such as a sleeve or cuff 108A and 108B for attaching to or receiving therewith or therein a portion of the wireless earbuds 110A and 110B. The wireless earbud couplers 102A and 102B may wholly (e.g., FIGS. 1-3) or partially encircle (FIGS. 4 and 5) a portion of the respective wireless earbuds 110A and 110B.

Further, the wireless earbud couplers 102A and 102B may retain the wireless earbuds 110A and 110B through friction means (compression and tension), other mechanical means such as magnetics, threads, and Velcro, as well as through adhesive means or other retention techniques. Further, the wireless earbud couplers 102A and 102B may be configured for temporary or permanent attachment.

Yet further, the wireless earbud lanyard 100A may further include an alternative intermediate coupling means or intermediate couplers 106A and 106B for intermediately coupling between the tether 104A and the wireless earbud couplers 102A and 102B. The wireless earbud couplers 102A and 102B and/or any intermediate couplers 106A and 106B may be formed from plastic, rubber, metal, synthetic, cloth, or other suitable material. The alternative intermediate couplers 106A and 106B may further be a manufacturing transition between the wireless earbud couplers 102A and 102B and the tether 104 rather than a discrete separate portion.

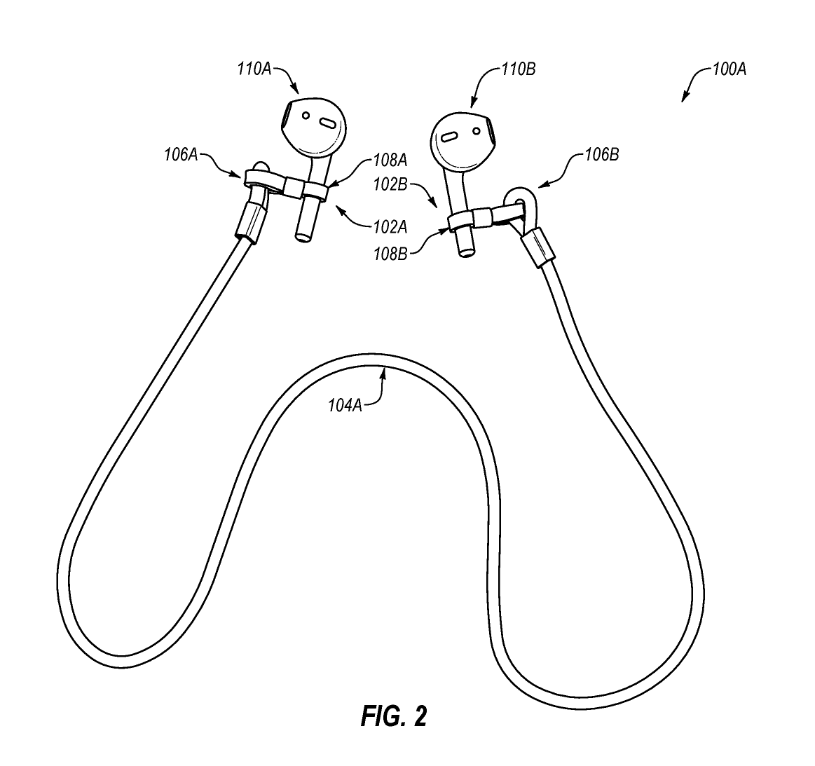

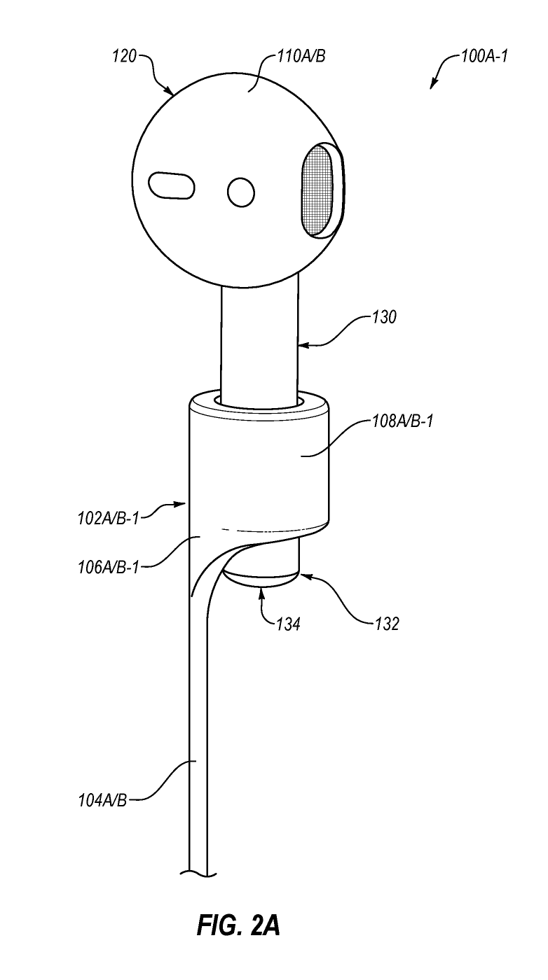

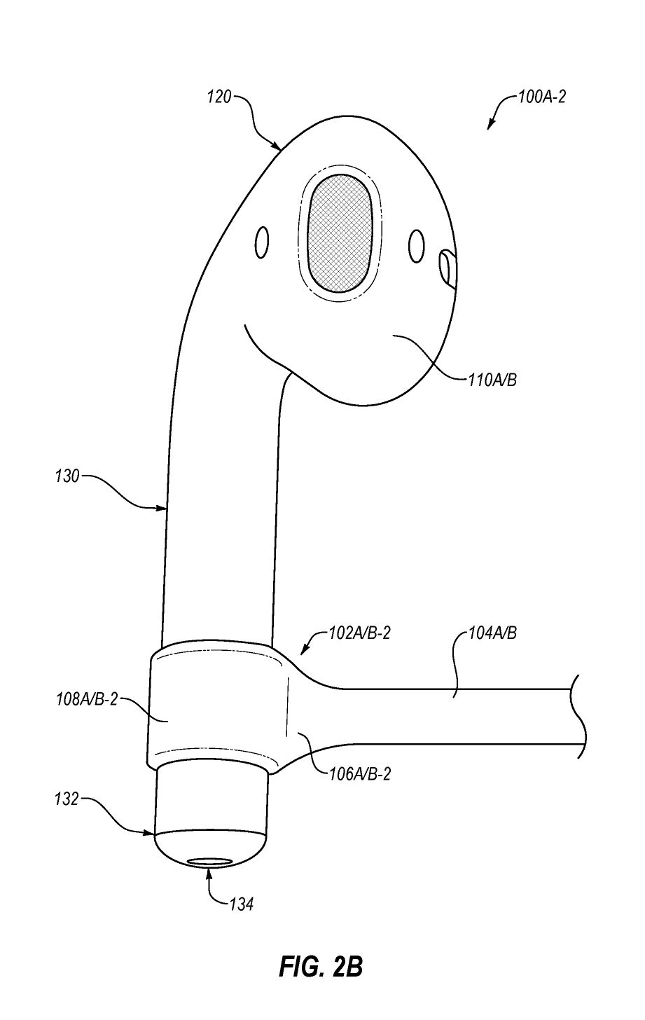

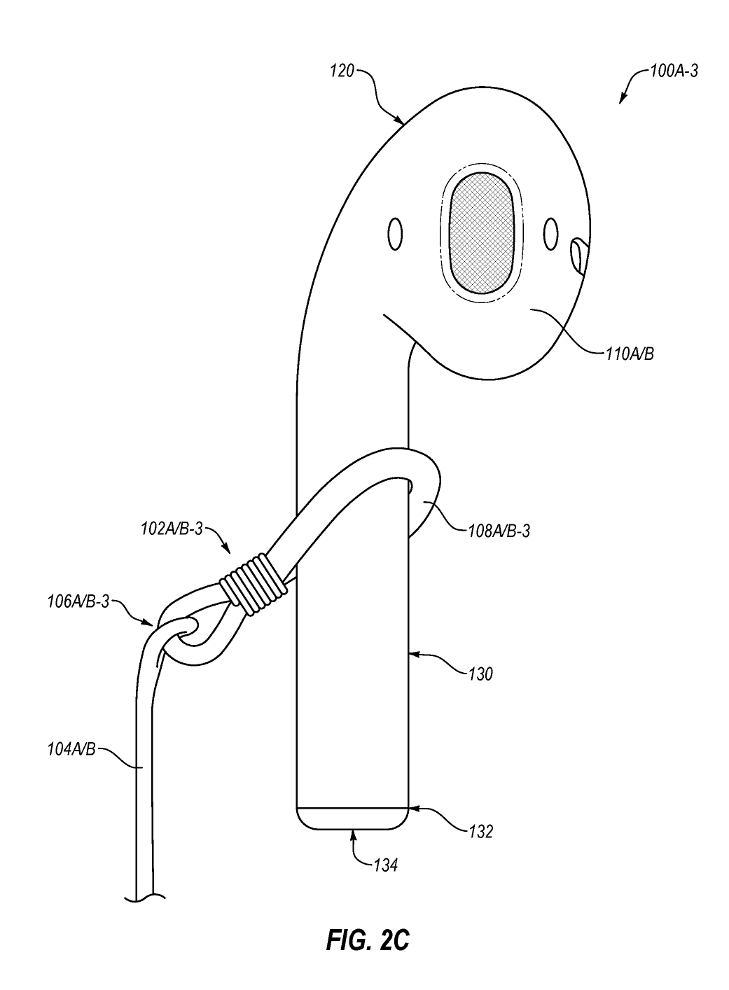

FIG. 2 illustrates and alternate view of the wireless earbud lanyard 100A of FIG. 1. Further, while FIGS. 1 and 2 illustrate the wireless earbud coupling couplers 102A and 102B for coupling to an elongated terminal end (e.g., a microphone boom) of the wireless earbuds 110A and 110B, the wireless earbud couplers 102A and 102B may couple to another portion (e.g., a bulbous end such as the speaker end) of the wireless earbuds 110A and 110B.

FIG. 2A illustrates a detailed view for coupling the wireless earbuds according to the wireless earbud lanyard 100A-1. The wireless earbud lanyard 100A-1 may include a wireless earbud coupler 102A/B-1 for coupling to a wireless earbud 110A/B. The wireless earbud 110A/B may include one or more portions, an example of which may include a first portion 120 configured for outputting audio signals to the wireless earbud 110A/B and an elongated or second portion 130 configured for inputting audio signal to the wireless earbud 110A/B. While the figures herein depict the first portion 120 as being more bulbous, and the elongated or second portion 130 being more elongated, such depictions are not to be considered limiting.

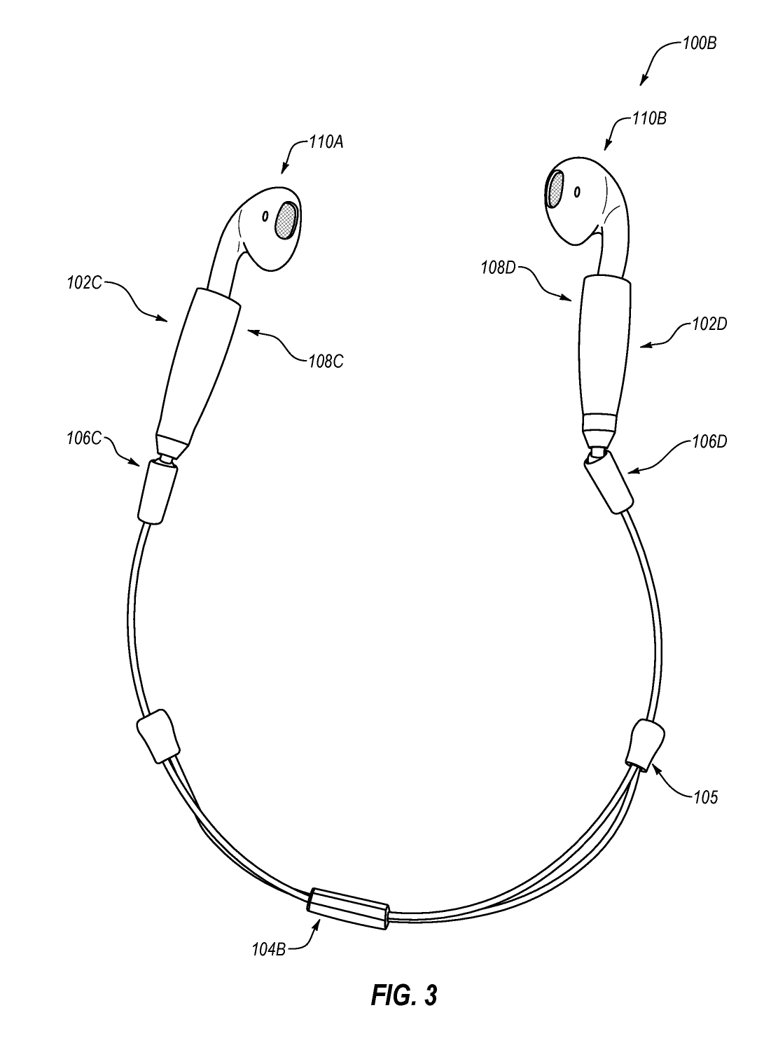

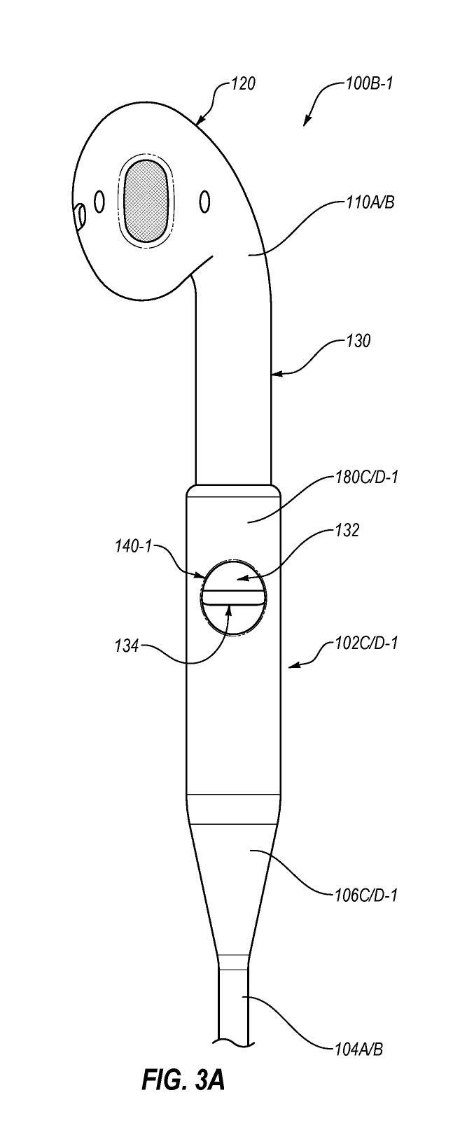

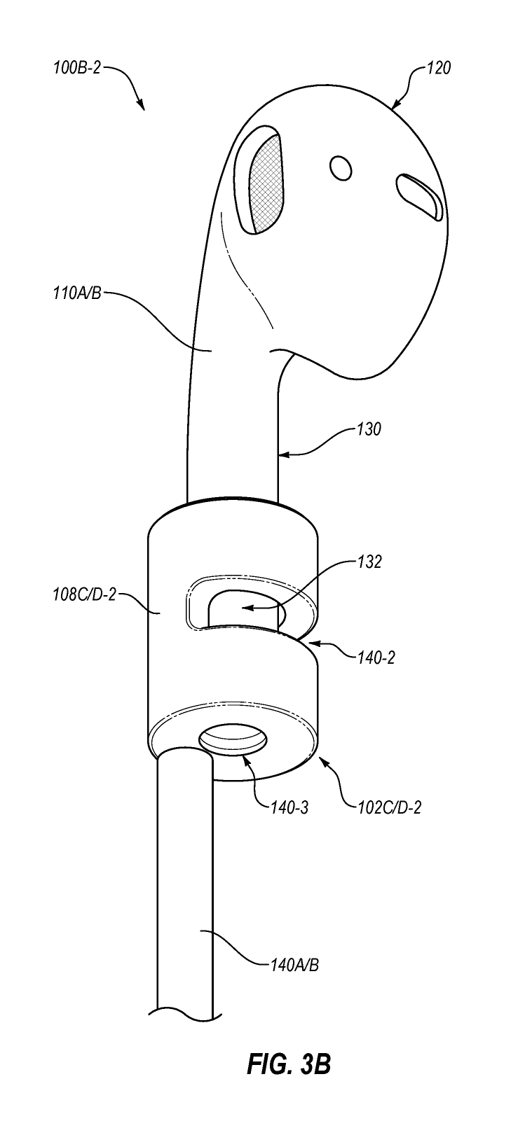

By way of example, the wireless earbud coupler 102A/B-1 may include a portion, such as sleeve 108A/B-1, for receiving or attaching to the wireless earbud 110A/B. The sleeve 108A/B-1 may be arranged substantially longitudinal to the tether 104A as depicted in FIG. 2A or 104B as depicted in FIG. 3, hereinafter tether 104A/B. The sleeve 108A/B-1 may be configured to receive at least a portion of one of the first portion 120 or the elongated or second portion 130 of the wireless earbud 110A/B. The sleeve 108A/B-1 may be of a shortened length to extend along a portion of the first portion 120 or the elongated or second portion 130 allowing for an end portion 132, which may include a microphone 134, of the elongated or second portion 130 of the wireless earbud 110A/B to extend beyond the sleeve 108A/B-1. Alternatively, the sleeve 108A/B-1 may extend along the entire portion of one of the first portion 120 or the elongated or second portion 130. Further, the sleeve 108A/B-1 may extend along a portion of one of the first portion 120 or the elongated or second portion 130 and extend past the end of the portion, as illustrated and described below with respect to FIG. 3A.

Wireless earbud coupler 102A/B-1 may couple directly to the tether 104A/B or may include an intermediate coupler 106A/B-1 which may be an integral transitional structure with one or both of the wireless earbud coupler 102A/B-1 or the tether 104A/B.

Wireless earbud lanyard 100A-1 may be integrally formed from a material such as silicone, rubber, elastomers, plastic, metal, composites, etc. Further, the respective components of the wireless earbud lanyard 100A-1, including the wireless earbud coupler 102A/B-1, an alternative intermediate coupler 106A/B-1, and the tether 104A/B may be comprised of different materials.

The wireless earbud coupler 102A/B-1 may retain the wireless earbud 110A/B using one or more of friction means (compression and tension), other mechanical means such as magnetics, threads, and Velcro, as well as through adhesive means or other retention techniques. Further, the wireless earbud coupler 102A/B-1 may be configured for temporary or permanent attachment to the wireless earbuds 110A/B.

FIG. 2B illustrates a detailed view for coupling the wireless earbuds according to the wireless earbud lanyard 100A-2. The wireless earbud lanyard 100A-2 may include a wireless earbud coupler 102A/B-2 for coupling to a wireless earbud 110A/B. As stated, the wireless earbud 110A/B may include one or more portions, an example of which may include a first portion 120 configured for outputting audio signals to the wireless earbud 110A/B and an elongated or second portion 130 configured for inputting audio signal to the wireless earbud 110A/B. While the figures herein depict the first portion 120 as being more bulbous, and the elongated or second portion 130 being more elongated, such depictions are not to be considered limiting.

By way of example, the wireless earbud coupler 102A/B-2 may include a portion, such as sleeve 108A/B-2, for receiving or attaching to the wireless earbud 110A/B. The sleeve 108A/B-2 may be arranged substantially perpendicular to the tether 104A/B as depicted in FIG. 2B. The sleeve 108A/B-2 may be configured to receive at least a portion of one of the first portion 120 or the elongated or second portion 130 of the wireless earbud 110A/B. The sleeve 108A/B-2 may be of a shortened length to extend along a portion of the first portion 120 or the elongated or second portion 130 allowing for an end portion 132, which may include a microphone 134, of the elongated or second portion 130 of the wireless earbud 110A/B to extend beyond the sleeve 108A/B-2. Alternatively, the sleeve 108A/B-2 may extend along the entire portion of one of the first portion 120 or the elongated or second portion 130. Further, the sleeve 108A/B-2 may extend along a portion of one of the first portion 120 or the elongated or second portion 130 and extend past the end of the portion, as illustrated and described below with respect to FIG. 3A.

Wireless earbud coupler 102A/B-2 may couple directly to the tether 104A/B or may include an intermediate coupler 106A/B-2 which may be an integral transitional structure with one or both of the wireless earbud coupler 102A/B-2 or the tether 104A/B.

Wireless earbud lanyard 100A-2 may be integrally formed from a material such as silicone, rubber, elastomers, plastic, metal, composites, etc. Further, the respective components of the wireless earbud lanyard 100A-2, including the wireless earbud coupler 102A/B-2, an alternative intermediate coupler 106A/B-2, and the tether 104A/B may be comprised of different materials.

The wireless earbud coupler 102A/B-2 may retain the wireless earbud 110A/B using one or more of friction means (compression and tension), other mechanical means such as magnetics, threads, and Velcro, as well as through adhesive means or other retention techniques. Further, the wireless earbud coupler 102A/B-2 may be configured for temporary or permanent attachment to the wireless earbuds 110A/B.

FIG. 2C illustrates a detailed view for coupling the wireless earbuds according to the wireless earbud lanyard 100A-3. The wireless earbud lanyard 100A-3 may include a wireless earbud coupler 102A/B-3 for coupling to a wireless earbud 110A/B. As stated, the wireless earbud 110A/B may include one or more portions, an example of which may include a first portion 120 configured for outputting audio signals to the wireless earbud 110A/B and an elongated or second portion 130 configured for inputting audio signal to the wireless earbud 110A/B. While the figures herein depict the first portion 120 as being more bulbous, and the elongated or second portion 130 being more elongated, such depictions are not to be considered limiting.

By way of example, the wireless earbud coupler 102A/B-3 may include a portion, such as sleeve 108A/B-3, for receiving or attaching to the wireless earbud 110A/B. The sleeve 108A/B-3 may be arranged substantially hinged or flexible with respect to the tether 104A/B as depicted in FIG. 2C. The sleeve 108A/B-3 may be configured to receive at least a portion of one of the first portion 120 or the elongated or second portion 130 of the wireless earbud 110A/B. The sleeve 108A/B-3 may be configured as a cord (of various circular or polygon cross-sectional dimension) to extend around a portion of the first portion 120 or the elongated or second portion 130 allowing for an end portion 132, which may include a microphone 134, of the elongated or second portion 130 of the wireless earbud 110A/B to extend beyond the sleeve 108A/B-3.

Wireless earbud coupler 102A/B-3 may couple directly to the tether 104A/B or may include an intermediate coupler 106A/B-3 which may be an integral transitional structure with one or both of the wireless earbud coupler 102A/B-2 or the tether 104A/B, or may be chain-coupled as illustrated in FIG. 2C. Further, the intermediate coupler 106A/B-3 may also find application to the various other embodiments described herein.

Wireless earbud lanyard 100A-3 may be integrally formed from a material such as silicone, rubber, elastomers, plastic, metal, composites, etc. Further, the respective components of the wireless earbud lanyard 100A-3, including the wireless earbud coupler 102A/B-3, an alternative intermediate coupler 106A/B-3, and the tether 104A/B may be comprised of different materials.

The wireless earbud coupler 102A/B-3 may retain the wireless earbud 110A/B using one or more of friction means (compression and tension), other mechanical means such as magnetics, threads, and Velcro, as well as through adhesive means or other retention techniques. Further, the wireless earbud coupler 102A/B-3 may be configured for temporary or permanent attachment to the wireless earbuds 110A/B.

FIG. 3 illustrates an alternate wireless earbud lanyard 100B including a connecting means or tether 104B including a wireless earbud coupling means or wireless earbud couplers 102C and 102D attached at the respective ends. The tether 104B may be a string, cord, cable, chain, or other similar means. Further, the tether 104B may include further mechanisms 105 for altering the effective length of the tether 104B. The wireless earbud couplers 102C and 102D may include a structure such as a sleeve or cuff 108C and 108D for attaching to or receiving a portion of the wireless earbuds 110A and 110B. The wireless earbud couplers 102C and 102D may wholly (e.g., FIGS. 1-3) or partially encircle (FIGS. 4 and 5) a portion of the respective wireless earbuds 110A and 110B. Further, the wireless earbud couplers 102C and 102D may be further configured in a cup or sleeve shape, as illustrated in FIG. 3, to receive a terminal portion or extending member such as elongated portion 130 of the wireless earbuds 110A and 110B. The wireless earbud couplers 102C and 102D may be configured as a resilient (e.g., rubber-like) material, and may include one or more cut-outs or perforations to allow sound to pass to or from a transducer such as a microphone or speaker.

Further, the wireless earbud couplers 102C and 102D may retain the wireless earbuds 110A and 110B through friction means (compression and tension), other mechanical means such as magnetics and Velcro, as well as through adhesive means or other retention techniques. Further, the wireless earbud couplers 102C and 102D may be configured for temporary or permanent attachment including through friction means (compression and tension), other mechanical means such as magnetics, threads, and Velcro, as well as through adhesive means or other retention techniques.

Yet further, the wireless earbud lanyard 100B may further include intermediate coupling means such as intermediate couplers 106C and 106D for intermediately coupling between the tether 104B and the wireless earbud couplers 104C and 104D. The wireless earbud couplers 102C and 102D and/or any intermediate couplers 106C and 106D may be formed from plastic, rubber, metal, synthetic, cloth, or other suitable material.

Further, while FIG. 3 illustrates the wireless earbud couplers 102C and 102D coupling to an elongated terminal end of the wireless earbuds 110A and 110B, the wireless earbud couplers 102C and 102D may couple to another portion (e.g., a bulbous end such as the speaker end) of the wireless earbuds 110A and 110B.

FIG. 3A illustrates a detailed view for coupling the wireless earbuds according to the wireless earbud lanyard 100B-1. The wireless earbud lanyard 100B-1 may include a wireless earbud coupler 102C/D-1 for coupling to a wireless earbud 110A/B. As stated, the wireless earbud 110A/B may include one or more portions, an example of which may include a first portion 120 configured for outputting audio signals to the wireless earbud 110A/B and an elongated or second portion 130 configured for inputting audio signal to the wireless earbud 110A/B. While the figures herein depict the first portion 120 as being more bulbous, and the elongated or second portion 130 being more elongated, such depictions are not to be considered limiting.

By way of example, the wireless earbud coupler 102C/D-1 may include a portion, such as sleeve 108C/D-1, for receiving or attaching to the wireless earbud 110A/B. The sleeve 108C/D-1 may be arranged substantially longitudinal to the tether 104A/B as depicted in FIG. 3A. The sleeve 108C/D-1 may be configured to receive at least a portion of one of the first portion 120 or the elongated or second portion 130 of the wireless earbud 110A/B. The sleeve 108C/D-1 may be of a shortened length to extend along a portion of the first portion 120 or the elongated or second portion 130 with an end portion 132, which may include a microphone 134, being at least partially enclosed by the sleeve 108C/D-1, as illustrated and described below with respect to FIG. 3A.

Wireless earbud coupler 102C/D-1 may further include therein one or more apertures 140-1 for providing operational access, for example, to a microphone of the wireless earbud 110A/B. The operational access may include providing an acoustic pathway from a user to the microphone of the wireless earbud 110A/B. Alternatively, the one or more apertures 140-1 may provide pressure relief for the insertion and removal of the wireless earbud 110A/B into the wireless earbud couplers 102C/D.

Wireless earbud coupler 102C/D-1 may couple directly to the tether 104A/B or may include an intermediate coupler 106C/D-1 which may be an integral transitional structure with one or both of the wireless earbud coupler 102C/D-1 or the tether 104A/B.

Wireless earbud lanyard 100B-1 may be integrally formed from a material such as silicone, rubber, elastomers, plastic, metal, composites, etc. Further, the respective components of the wireless earbud lanyard 100B-1, including the wireless earbud coupler 102C/D-1, an alternative intermediate coupler 106C/D-1, and the tether 104A/B may be comprised of different materials.

The wireless earbud coupler 102C/D-1 may retain the wireless earbud 110A/B using one or more of friction means (compression and tension), other mechanical means such as magnetics, threads, and Velcro, as well as through adhesive means or other retention techniques. Further, the wireless earbud coupler 102C/D-1 may be configured for temporary or permanent attachment to the wireless earbuds 110A/B.

FIG. 3B illustrates a detailed view for coupling the wireless earbuds according to the wireless earbud lanyard 100B-2. The wireless earbud lanyard 100B-2 may include a wireless earbud coupler 102C/D-2 for coupling to a wireless earbud 110A/B. As stated, the wireless earbud 110A/B may include one or more portions, an example of which may include a first portion 120 configured for outputting audio signals to the wireless earbud 110A/B and a second portion 130 configured for inputting audio signal to the wireless earbud 110A/B. While the figures herein depict the first portion 120 as being more bulbous, and the second portion 130 being more elongated, such depictions are not to be considered limiting.

By way of example, the wireless earbud coupler 102C/D-2 may include a portion, such as sleeve 108C/D-2, for receiving or attaching to the wireless earbud 110A/B. The sleeve 108C/D-2 may be arranged substantially longitudinal to the tether 104A/B as depicted in FIG. 3B. The sleeve 108C/D-2 may be configured to receive at least a portion of one of the first portion 120 or the elongated or second portion 130 of the wireless earbud 110A/B. The sleeve 108C/D-2 may be of a shortened length to extend along a portion of the first portion 120 or the elongated or second portion 130 with an end portion 132, which may include a microphone 134, being at least partially enclosed by the sleeve 108C/D-2, as illustrated and described below with respect to FIG. 3B.

Wireless earbud coupler 102C/D-2 may further include therein one or more apertures 140-2 and/or 140-3 for providing operational access, for example, to a microphone of the wireless earbud 110A/B. The operational access may include providing an acoustic pathway from a user to the microphone of the wireless earbud 110A/B. Alternatively, the one or more apertures 140-2 and/or 140-3 may provide pressure relief for the insertion and removal of the wireless earbud 110A/B into the wireless earbud couplers 102C/D.

Wireless earbud coupler 102C/D-2 may couple directly to the tether 104A/B, as illustrated in FIG. 3B, or may include an intermediate coupler, as illustrated in the various other embodiments.

Wireless earbud lanyard 100B-2 may be integrally formed from a material such as silicone, rubber, elastomers, plastic, metal, composites, etc. Further, the respective components of the wireless earbud lanyard 100B-2, including the wireless earbud coupler 102C/D-2, an alternative intermediate coupler, and the tether 104A/B may be comprised of different materials.

The wireless earbud coupler 102C/D-2 may retain the wireless earbud 110A/B using one or more of friction means (compression and tension), other mechanical means such as magnetics, threads, and Velcro, as well as through adhesive means or other retention techniques. Further, the wireless earbud coupler 102C/D-2 may be configured for temporary or permanent attachment to the wireless earbuds 110A/B.

FIG. 4 illustrates a wireless earbud lanyard 100C including a connecting means or tether 104C. The wireless earbud lanyard 100C may further include a wireless earbud coupling means or wireless earbud couplers 102E and 102F attached at the respective ends of the tether 104C. The tether 104C may be a string, cord, cable, chain, or other similar means. The wireless earbud couplers 102E and 102F may include a structure such as a sleeve or cuff 108E and 108F for attaching to or receiving a portion of the wireless earbuds 110A and 110B.

The wireless earbud couplers 102 and 102 may wholly (e.g., FIGS. 1-3) or partially encircle (FIGS. 4 and 5) a portion of the respective earbuds 110A and 110B. Further, the earbud couplers 102E and 102F may be configured in a U-shaped or C-shaped configuration for allowing coupling to a partial portion of an extending member or elongated portion 130 of the wireless earbuds 110A and 110B. Further, the U-shaped or C-shaped configuration may allow one or both edges of the U-shaped or C-shaped configuration of the earbud couplers 102E and 102F to flex thereby allowing the wireless earbud 110A and 110B to “snap” into the inner diameter of the earbud couplers 102E and 102F.

Further, the wireless earbud couplers 102E and 102F may retain the wireless earbuds 110A and 110B through friction means (compression and tension), other mechanical means such as magnetics, threads, and Velcro, as well as through adhesive means or other retention techniques. Further, the wireless earbud couplers 102E and 102F may be configured for temporary or permanent attachment.

Yet further, the wireless earbud lanyard 100C may further include intermediate coupling means or intermediate couplers 106E and 106F for intermediately coupling between the tether 104C and the wireless earbud couplers 104E and 104F. The wireless earbud couplers 102E and 102F and/or any intermediate couplers 106E and 106F may be formed from plastic, rubber, metal, synthetic, or other suitable material.

FIG. 5 illustrates an alternate and close-up view of the wireless earbud lanyard 100C of FIG. 4.

FIG. 5A illustrates a detailed view for coupling the wireless earbuds according to the wireless earbud lanyard 100C-1. The wireless earbud lanyard 100C-1 may include a wireless earbud coupler 102E/F-1 for coupling to a wireless earbud 110A/B. The wireless earbud 110A/B may include one or more portions, an example of which may include a first portion 120 configured for outputting audio signals to the wireless earbud 110A/B and a elongated or second portion 130 configured for inputting audio signal to the wireless earbud 110A/B. While the figures herein depict the first portion 120 as being more bulbous, and the elongated or second portion 130 being more elongated, such depictions are not to be considered limiting.

By way of example, the wireless earbud coupler 102E/F-1 may include a portion, such as sleeve 108E/F-1, for receiving or attaching to the wireless earbud 110A/B. The sleeve 108E/F-1 may be arranged substantially longitudinal to the tether 104A/B. The sleeve 108E/F-1 may be configured to receive at least a portion of one of the first portion 120 or the elongated or second portion 130 of the wireless earbud 110A/B. The sleeve 108E/F-1 may be of a shortened length to extend along a portion of the first portion 120 or the elongated or second portion 130 allowing for an end portion 132, which may include a microphone 134, of the elongated or second portion 130 of the wireless earbud 110A/B to extend beyond the sleeve 108E/F-1. Alternatively, the sleeve 108E/F-1 may extend along the entire portion of one of the first portion 120 or the elongated or second portion 130. Further, the sleeve 108E/F-1 may extend along a portion of one of the first portion 120 or the elongated or second portion 130 and extend past the end of the portion, as illustrated and described below with respect to FIG. 3A. Further, the sleeve 108E/F-1 may have formed therein a slot 150 to provide a diameter within the sleeve 108E/F-1 that is smaller than the diameter of the received portion of the wireless earbud 110A/B. The reduced inner diameter of the sleeve 108E/F-1 may provide retentive compression when the received portion of the wireless earbud 110A/B is placed therein.

Wireless earbud coupler 102E/F-1 may couple directly to the tether 104A/B or may include an intermediate coupler 106E/F-1 which may be an integral transitional structure with one or both of the wireless earbud coupler 102E/F-1 or the tether 104A/B.

Wireless earbud lanyard 100C-1 may be integrally formed from a material such as silicone, rubber, elastomers, plastic, metal, composites, etc. Further, the respective components of the wireless earbud lanyard 100C-1, including the wireless earbud coupler 102E/F-1, an alternative intermediate coupler 106E/F-1, and the tether 104A/B may be comprised of different materials.

The wireless earbud coupler 102E/F-1 may retain the wireless earbud 110A/B using one or more of friction means (compression and tension), other mechanical means such as magnetics, threads, and Velcro, as well as through adhesive means or other retention techniques. Further, the wireless earbud coupler 102E/F-1 may be configured for temporary or permanent attachment to the wireless earbuds 110A/B.

It is noted that portions of one embodiment described herein may be exchanged and incorporated with other portions of other embodiments. Such various combinations are contemplated and within the scope of the disclosure. Further, one wireless earbud coupling means may be configured to differently hold (one more permanently attached and one more temporarily attached) the respective wireless earbuds.

The previous description of the disclosure is provided to enable any person skilled in the art to make or use the disclosure. Various modifications to the disclosure will be readily apparent to those skilled in the art, and the generic principles defined herein may be applied to other variations without departing from the scope of the disclosure. Thus, the disclosure is not intended to be limited to the examples and designs described herein but is to be accorded the widest scope consistent with the principles and novel features disclosed herein.

What is claimed is:

1. A wireless earbud lanyard, comprising:
a first wireless earbud coupler and a second wireless earbud coupler, the first and second wireless earbud couplers each shaped to attachably and detachably receive at least a portion of an elongated portion of respective first and second wireless earbuds; and
a tether having a first end coupled to the first wireless earbud coupler and a second end coupled to the second wireless earbud coupler.

2. The wireless earbud lanyard of claim 1, wherein each of the first and second wireless earbud couplers configured for attachment away from a terminal end of the elongated portion of the respective first and second wireless earbuds.

3. The wireless earbud lanyard of claim 1, wherein each of the first and second wireless earbud couplers is configured as a sleeve including an inner cross-section substantially corresponding to an outer cross-section of the elongated portion of each of the first and second wireless earbuds.

4. The wireless earbud lanyard of claim 1, wherein the sleeve of each of the first and second wireless earbud couplers includes a slot along a longitudinal length of each of the first and second wireless earbud couplers.

5. The wireless earbud lanyard of claim 4, wherein the sleeve of each of the first and second couplers includes an internal cross-sectional profile substantially corresponding to an external cross-sectional profile of the elongated portion of the wireless earbud.

6. The wireless earbud lanyard of claim 1, wherein the first and second ends of the tether substantially longitudinally extend from the respective first and second wireless earbud couplers.

7. The wireless earbud lanyard of claim 1, wherein the first and second ends of the tether substantially perpendicularly extend from the respective first and second wireless earbud couplers.

8. The wireless earbud lanyard of claim 1, wherein the first and second wireless earbud couplers are configure as compressive cord.

9. The wireless earbud lanyard of claim 1, wherein each of the first and second couplers each configured in a cup-shape to receive a terminal end of the elongated portion of the wireless earbud.

10. The wireless earbud lanyard of claim 9, wherein the first and second couplers each configured in a cup-shape each further have formed therein an aperture substantially located near a location of the terminal end of the elongated portion of the wireless earbud when inserted into each of the first and second wireless earbud couplers.

11. A wireless earbud lanyard, comprising:
first and second wireless earbud couplers, each of the first and second wireless earbud couplers configured to attachably and detachably receive therein at least a portion of an elongated portion of a wireless earbud, provide one or more of friction and compression retention to the elongated portion of the wireless earbud, and allow acoustic coupling to a terminal end of the elongated portion of the wireless earbud; and
a tether having a first end coupled to the first wireless earbud coupler and a second end coupled to the second wireless earbud coupler.

12. The wireless earbud lanyard of claim 11, wherein the first and second earbud couplers are integrally coupled to the tether.

13. The wireless earbud lanyard of claim 11, wherein the first and second wireless earbud couplers are configured as respective first and second sleeves each configured to receive therein the at least a portion of the elongated portion of the wireless earbud.

14. The wireless earbud lanyard of claim 13, wherein each of the first and second sleeves of the first and second couplers include an internal cross-sectional profile substantially corresponding to an external cross-sectional profile of the elongated portion of the wireless earbud.

15. The wireless earbud lanyard of claim 13, wherein each of the first and second sleeves of the first and second wireless earbud couplers include a slot along a longitudinal length of each of the first and second wireless earbud couplers.

16. The wireless earbud lanyard of claim 11, wherein each of the first and second couplers each configured in a cup-shape to receive a terminal end of the elongated portion of the wireless earbud.

17. The wireless earbud lanyard of claim 16, wherein the first and second couplers each configured in a cup-shape each further have formed therein an aperture substantially located near a location of the terminal end of the elongated portion of the wireless earbud when inserted into each of the first and second wireless earbud couplers.

18. A wireless earbud lanyard, comprising:
first and second wireless earbud couplers, each of the first and second wireless earbud couplers including a sleeve including an inner diameter substantially the same as an outer diameter of a cross-section of an elongated portion of a wireless earbud, the sleeve configured to attachably and detachably receive therein at least a portion of the elongated portion of a wireless earbud, the sleeve further configured for coupling away from a microphone on a terminal end of each of the first and second wireless earbuds, provide one or more of friction and compression retention to the elongated portion of the wireless earbud; and
a tether having a first end coupled to the first wireless earbud coupler and a second end coupled to the second wireless earbud coupler.

19. The wireless earbud lanyard of claim 18, wherein the sleeve includes a slot along a longitudinal length of each of the first and second wireless earbud couplers.

20. The wireless earbud lanyard of claim 18, wherein the first and second ends of the tether one of substantially longitudinally or perpendicularly extend from the respective first and second wireless earbud couplers.
